(19) United States
(12) Patent Application Publication
(10) Pub. No.: US 2019/0212751 A1
(43) Pub. Date: Jul. 11, 2019

(54) METHOD AND SYSTEM FOR OPERATING A MOVABLE OBJECT TO AVOID OBSTACLES

(71) Applicant: SZ DJI TECHNOLOGY CO., LTD., Shenzhen (CN)

(72) Inventors: You ZHOU, Shenzhen (CN); Ketan TANG, Shenzhen (CN); Cong ZHAO, Shenzhen (CN); Jiaqi YAN, Shenzhen (CN); Jiexi DU, Shenzhen (CN)

(21) Appl. No.: 16/354,775

(22) Filed: Mar. 15, 2019

Related U.S. Application Data
(63) Continuation of application No. PCT/CN2016/099187, filed on Sep. 18, 2016.

(51) Int. Cl. G05D 1/02; G06K 9/00; G06T 7/70; G06T 7/20

(52) U.S. Cl. CPC G05D 1/0246; G06K 9/00805; G06T 2207/30261; G06T 7/20; G06T 7/70

(57) ABSTRACT

A method for operating a movable object includes acquiring a plurality of image frames captured within a predefined time window by an imaging device borne by the movable object moving along a navigation path, identifying one or more objects adjacent the movable object by measuring pixel movements within the plurality of image frames, estimating movements of the one or more objects relative to the movable object using dimensional variations of the one or more objects within the plurality of image frames, and adjusting the navigation path of the movable object in accordance with the estimated movements of the one or more objects.

### CROSS-REFERENCE TO RELATED APPLICATION

This application is a continuation of International Application No. PCT/CN2016/099187, filed on Sep. 18, 2016, the entire contents of which are incorporated herein by reference.

### TECHNICAL FIELD

The disclosed embodiments relate generally to operating a movable object and more particularly, but not exclusively, to operating a movable object to avoid obstacles.

### BACKGROUND

Movable objects such as unmanned aerial vehicles (UAVs) can be used for performing surveillance, reconnaissance, and exploration tasks for military and civilian applications. A movable object may carry a payload configured to perform a specific function, such as capturing images of the surrounding environment for detecting and avoiding obstacles in the surrounding environment. It is important to efficiently detect obstacles and estimate positions and movements of the movable object relative to the obstacles, such that navigation path can be timely updated to avoid collisions between the movable object and the obstacles.

### SUMMARY

There is a need for systems and methods for operating a movable object for efficient and effective obstacle avoidance, including detecting one or more obstacles in the environment, estimating movements of the one or more obstacles relative to the movable object, and navigating the movable object to avoid the one or more obstacles in accordance with the estimated movements. Such systems and methods optionally complement or replace conventional methods for controlling a movable object. By using image processing techniques to analyze image data captured by an imaging device borne by the movable object, some embodiments of the present application can significantly improve the efficiency and convenience in obstacle avoidance for the movable object. Additionally, the image processing techniques as disclosed herein do not require data to be gathered from stereoscopic imaging sensors or powerful inertial measurement unit (IMU) borne by the movable object. Thus neither sophisticated mechanical design and/or calibration, nor complicated computation is needed.

In accordance with some embodiments, a method for operating a movable object to avoid obstacles comprises: acquiring a plurality of image frames. The plurality of images are captured within a predefined time window by an imaging device borne by the movable object moving along a navigation path. The method further comprises identifying one or more objects adjacent the movable object by measuring pixel movements within the plurality of image frames. The method further comprises estimating movements of the one or more objects relative to the movable object using dimensional variations of the one or more objects within the plurality of image frames. The method also comprises adjusting the navigation path of the movable object in accordance with the estimated movements of the one or more objects.

In accordance with some embodiments, an unmanned aerial vehicle (UAV) may comprise a propulsion system, one or more sensors, an imaging device, and one or more processors coupled to the propulsion system, the one or more sensors, and the imaging device. The one or more processors are configured for performing the operations of the above method. In accordance with some embodiments, a system may comprise an imaging device; one or more processors coupled to the imaging device; memory; and one or more programs. The one or more programs are stored in the memory and configured to be executed by the one or more processors. The one or more programs including instructions for performing the operations of the above method. In accordance with some embodiments, a non-transitory computer-readable storage medium has stored therein instructions that, when executed by the movable object, cause the movable object to perform the operations of the above method.

### BRIEF DESCRIPTION OF THE DRAWINGS

FIG. 1 illustrates a movable object environment, in accordance with some embodiments.

FIG. 2 illustrates a movable object, in accordance with some embodiments.

FIG. 3 is a flow diagram illustrating a method of operating a movable object to avoid obstacles, in accordance with some embodiments.

FIG. 4 illustrates an exemplary user interface for operating a movable object as the movable object moves along a navigation path, in accordance with some embodiments.

FIG. 5 is an exemplary diagram illustrating one or more optical flow vectors formed based on two image frames, in accordance with some embodiments.

FIG. 6 illustrates an exemplary user interface of an optical flow vector map formed based on two image frames, in accordance with some embodiments.

FIG. 7 illustrates an exemplary user interface of identifying one or more objects based on the optical flow vector map, in accordance with some embodiments.

FIG. 8 illustrates an exemplary user interface displaying time-to-hit values associated with one or more objects, in accordance with some embodiments.

FIG. 9 illustrates an exemplary user interface of displaying a navigation path for operating a movable object to avoid obstacles, in accordance with some embodiments.

FIGS. 10A-10D are a flow diagram illustrating a method for operating a movable object, in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The following description uses an unmanned aerial vehicle (UAV) as an example of a movable object. UAVs include, e.g., fixed-wing aircrafts and rotary-wing aircrafts such as helicopters, quadcopters, and aircraft having other numbers and/or configurations of rotors. In some embodiments, the movable object also includes, but is not limited to, a self-driving car (i.e., an autonomous car, a driverless car), a virtual reality (VR) headset, an augmented reality (AR) headset, a handheld gimbal with a camera and image processing capabilities. It will be apparent to those skilled in the art that other types of movable objects may be substituted for UAVs as described below, such as a mobile phone, a tablet, or a remote control.

The present disclosure provides techniques related to operating UAVs for obstacle avoidance. In some embodiments, a plurality of images are captured using an imaging device borne by a UAV moving along a navigation path. Image processing techniques disclosed in the present application are used to process the captured images for identifying one or more obstacles in the environment of the UAV and for estimating movements of the one or more obstacles relative to the UAV. The navigation path of the UAV is adjusted based on the estimated movements and one or more operation parameters of the UAV are adjusted accordingly. For example, a time-to-hit value for a UAV to reach an identified obstacle is determined based on a rate of dimensional variation of the identified obstacle. Some embodiments of the present application do not need image data obtained from stereoscopic image sensors (e.g., stereoscopic cameras) borne by a UAV, thus there is no requirement of complicated system design, sophisticated mechanical structure, or delicate calibration process. Some embodiments of the present application do not need positional information of the imaging sensor which is obtained from one or more sensors of an inertial measurement unit (IMU) system borne by a UAV, thus neither a calibration process between the imaging device and the IMU nor complex computation of the positional information and imaging data is needed. Efficient (e.g., in real-time) and accurate obstacle detection and obstacle avoidance as the UAV moves along a navigation path can be achieved using the image processing techniques disclosed in the present application.

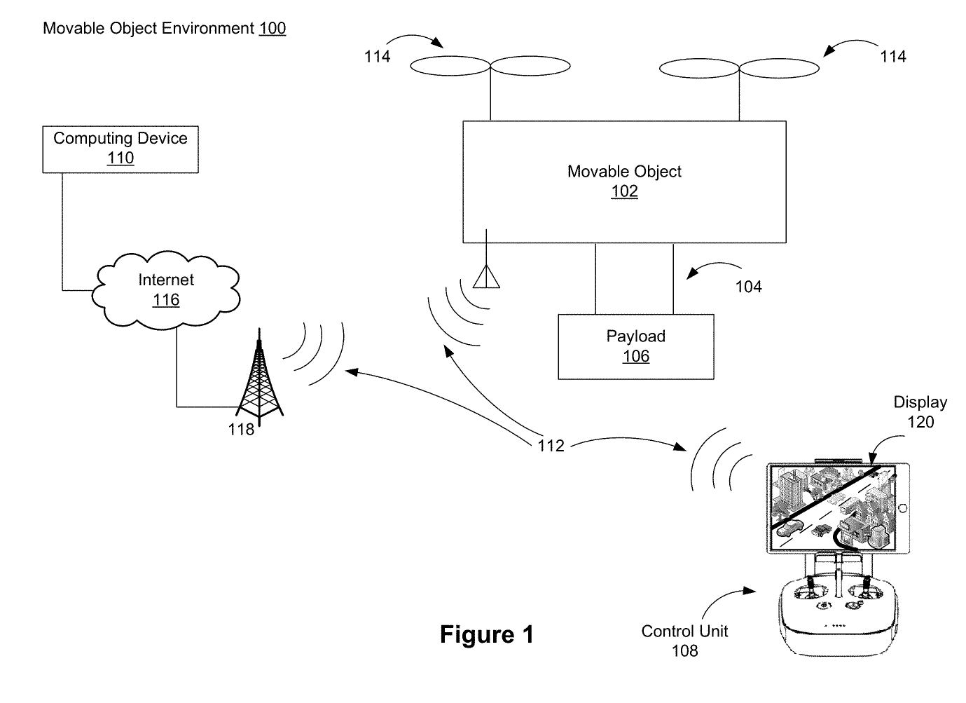

FIG. 1 illustrates a movable object environment 100, in accordance with some embodiments. The movable object environment 100 includes a movable object 102. In some embodiments, the movable object 102 includes a carrier 104 and/or a payload 106.

In some embodiments, the carrier 104 is used to couple the payload 106 to the movable object 102. In some embodiments, the carrier 104 includes an element (e.g., a gimbal and/or damping element) to isolate the payload 106 from movement of the movable object 102 and/or the movement mechanism 114. In some embodiments, the carrier 104 includes an element for controlling movement of the payload 106 relative to the movable object 102.

In some embodiments, the payload 106 is coupled (e.g., rigidly coupled) to the movable object 102 (e.g., coupled via carrier 104) such that the payload 106 remains substantially stationary relative to movable object 102. For example, the carrier 104 is coupled to the payload 106 such that the payload is not movable relative to the movable object 102. In some embodiments, the payload 106 is mounted directly to the movable object 102 without requiring the carrier 104. In some embodiments, the payload 106 is located partially or fully within the movable object 102.

In some embodiments, a control unit 108 communicates with the movable object 102, e.g., to provide control instructions to the movable object 102 and/or to display information received from the movable object 102 on a display 120. Although the control unit 108 is typically a portable (e.g., handheld) device, the control unit 108 need not be portable. In some embodiments, the control unit 108 is a dedicated control device (e.g., for the movable object 102), a laptop computer, a desktop computer, a tablet computer, a gaming system, a wearable device (e.g., glasses, a glove, and/or a helmet), a microphone, a portable communication device (e.g., a mobile telephone) and/or a combination thereof.

In some embodiments, an input device of the control unit 108 receives user input to control aspects of the movable object 102, the carrier 104, the payload 106, and/or a component thereof. Such aspects include, e.g., orientation, position, orientation, velocity, acceleration, navigation, and/or tracking. For example, a position of an input device of the control unit 108 (e.g., a position of a component of the input device) is manually set by a user to a position corresponding to an input (e.g., a predetermined input) for controlling the movable object 102. In some embodiments, the input device is manipulated by a user to input control instructions for controlling the navigation of the movable object 102. In some embodiments, an input device of control unit 108 is used to input a flight mode for the movable object 102, such as auto pilot or navigation according to a predetermined navigation path.

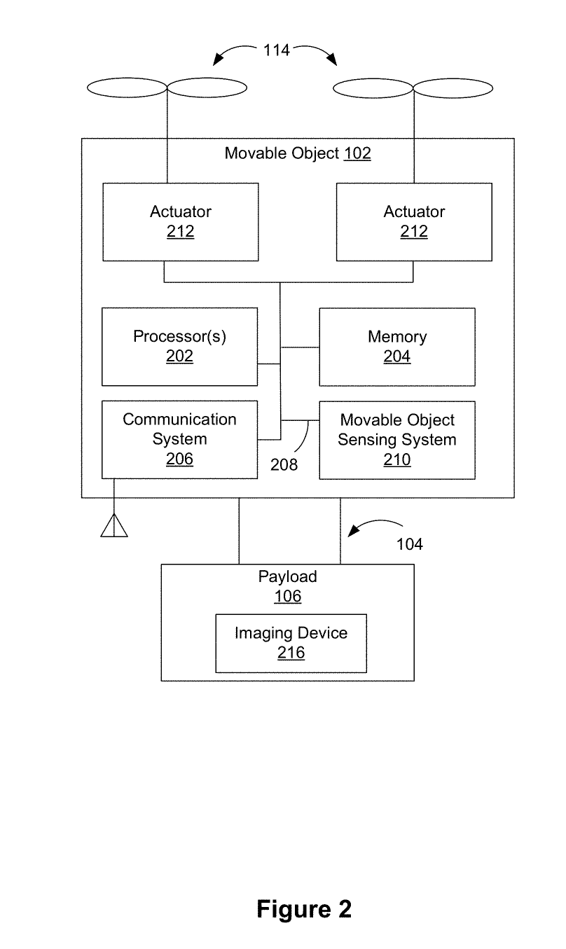

In some embodiments, the display 120 of the control unit 108 displays information generated by the movable object sensing system 210, the memory 204, and/or another system of the movable object 102. For example, the display 120 displays information about the movable object 102, the carrier 104, and/or the payload 106, such as position, orientation, orientation, movement characteristics of the movable object 102, and/or distance between the movable object 102 and another object (e.g., a target and/or an obstacle). In some embodiments, information displayed by the display 120 of control unit 108 includes images captured by an imaging device 216 (FIG. 2), tracking data (e.g., a graphical tracking indicator applied to a representation of a target), and/or indications of control data transmitted to the movable object 102. In some embodiments, information displayed by the display 120 of the control unit 108 is displayed in substantially real-time as information is received from the movable object 102 and/or as image data is acquired. In some embodiments, the display 120 of the control unit 108 is a touchscreen display.

In some embodiments, the movable object environment 100 includes a computing device 110. The computing device 110 is, e.g., a server computer, a cloud server, a desktop computer, a laptop computer, a tablet, or another portable electronic device (e.g., a mobile telephone). In some embodiments, the computing device 110 is a base station that communicates (e.g., wirelessly) with the movable object 102 and/or the control unit 108. In some embodiments, the computing device 110 provides data storage, data retrieval, and/or data processing operations, e.g., to reduce the processing power and/or data storage requirements of the movable object 102 and/or the control unit 108. For example, the computing device 110 is communicatively connected to a database and/or the computing device 110 includes a database. In some embodiments, the computing device 110 is used in lieu of or in addition to the control unit 108 to perform any of the operations described with regard to the control unit 108.

In some embodiments, the movable object 102 communicates with a control unit 108 and/or a computing device 110, e.g., via wireless communications 112. In some embodiments, the movable object 102 receives information from the control unit 108 and/or the computing device 110. For example, information received by the movable object 102 includes, e.g., control instructions for controlling movable object 102. In some embodiments, the movable object 102 transmits information to the control unit 108 and/or the computing device 110. For example, information transmitted by the movable object 102 includes, e.g., images and/or video captured by the movable object 102.

In some embodiments, communications between the computing device 110, the control unit 108 and/or the movable object 102 are transmitted via a network (e.g., Internet 116) and/or a wireless signal transmitter (e.g., a long range wireless signal transmitter) such as a cellular tower 118. In some embodiments, a satellite (not shown) is a component of Internet 116 and/or is used in addition to or in lieu of the cellular tower 118.

In some embodiments, information communicated between the computing device 110, the control unit 108 and/or the movable object 102 include control instructions. Control instructions include, e.g., navigation instructions for controlling navigational parameters of the movable object 102 such as position, orientation, orientation, and/or one or more movement characteristics of the movable object 102, the carrier 104, and/or the payload 106. In some embodiments, control instructions include instructions directing movement of one or more of the movement mechanisms 114. For example, control instructions are used to control flight of a UAV.

In some embodiments, control instructions include information for controlling operations (e.g., movement) of the carrier 104. For example, control instructions are used to control an actuation mechanism of the carrier 104 so as to cause angular and/or linear movement of the payload 106 relative to the movable object 102. In some embodiments, control instructions adjust movement of the carrier 104 relative to the movable object 102 with up to six degrees of freedom.

In some embodiments, control instructions are used to adjust one or more operational parameters for the payload 106. For example, control instructions include instructions for adjusting an optical parameter (e.g., an optical parameter of the imaging device 216). In some embodiments, control instructions include instructions for adjusting imaging properties and/or image device functions, such as capturing an image, initiating/ceasing video capture, powering an imaging device 216 on or off, adjusting an imaging mode (e.g., capturing still images or capturing video), adjusting a distance between left and right components of a stereographic imaging system, and/or adjusting a position, orientation, and/or movement (e.g., pan rate, pan distance) of a carrier 104, a payload 106 and/or an imaging device 216.

In some embodiments, when control instructions are received by movable object 102, the control instructions change parameters of and/or are stored by memory 204 (FIG. 2) of movable object 102.

FIG. 2 illustrates an exemplary movable object 102, in accordance with some embodiments. The movable object 102 typically includes one or more processor(s) 202, a memory 204, a communication system 206, a movable object sensing system 210, and one or more communication buses 208 for interconnecting these components.

In some embodiments, the movable object 102 is a UAV and includes components to enable flight and/or flight control. In some embodiments, the movable object 102 includes communication system 206 with one or more network or other communications interfaces (e.g., via which flight control instructions are received), one or more movement mechanisms 114, and/or one or more movable object actuators 212 (e.g., to cause movement of movement mechanisms 114 in response to received control instructions). Although the movable object 102 is depicted as an aircraft, this depiction is not intended to be limiting, and any suitable type of movable object can be used. Actuator 212 is, e.g., a motor, such as a hydraulic, pneumatic, electric, thermal, magnetic, and/or mechanical motor.

In some embodiments, the movable object 102 includes movement mechanisms 114 (e.g., propulsion mechanisms). Although the plural term “movement mechanisms” is used herein for convenience of reference, “movement mechanisms 114” refers to a single movement mechanism (e.g., a single propeller) or multiple movement mechanisms (e.g., multiple rotors). The movement mechanisms 114 include one or more movement mechanism types such as rotors, propellers, blades, engines, motors, wheels, axles, magnets, nozzles, and so on. The movement mechanisms 114 are coupled to the movable object 102 at, e.g., the top, bottom, front, back, and/or sides. In some embodiments, the movement mechanisms 114 of a single movable object 102 include multiple movement mechanisms of the same type. In some embodiments, the movement mechanisms 114 of a single movable object 102 include multiple movement mechanisms with different movement mechanism types. The movement mechanisms 114 are coupled to the movable object 102 using any suitable means, such as support elements (e.g., drive shafts) and/or other actuating elements (e.g., the movable object actuators 212). For example, a movable object actuator 212 receives control signals from the processor(s) 202 (e.g., via the control bus 208) that activates the movable object actuator 212 to cause movement of a movement mechanism 114. For example, the processor(s) 202 include an electronic speed controller that provides control signals to a movable object actuator 212.

In some embodiments, the movement mechanisms 114 enable the movable object 102 to take off vertically from a surface or land vertically on a surface without requiring any horizontal movement of the movable object 102 (e.g., without traveling down a runway). In some embodiments, the movement mechanisms 114 are operable to permit the movable object 102 to hover in the air at a specified position and/or orientation. In some embodiments, one or more of the movement mechanisms 114 are controllable independently of one or more of the other movement mechanisms 114. For example, when the movable object 102 is a quadcopter, each rotor of the quadcopter is controllable independently of the other rotors of the quadcopter. In some embodiments, multiple movement mechanisms 114 are configured for simultaneous movement.

In some embodiments, the movement mechanisms 114 include multiple rotors that provide lift and/or thrust to the movable object 102. The multiple rotors are actuated to provide, e.g., vertical takeoff, vertical landing, and hovering capabilities to the movable object 102. In some embodiments, one or more of the rotors spin in a clockwise direction, while one or more of the rotors spin in a counterclockwise direction. For example, the number of clockwise rotors is equal to the number of counterclockwise rotors. In some embodiments, the rotation rate of each of the rotors is independently variable, e.g., for controlling the lift and/or thrust produced by each rotor, and thereby adjusting the spatial disposition, velocity, and/or acceleration of the movable object 102 (e.g., with respect to up to three degrees of translation and/or up to three degrees of rotation).

In some embodiments, the memory 204 stores one or more instructions, programs (e.g., sets of instructions), modules, controlling systems and/or data structures, collectively referred to as “elements” herein. One or more elements described with regard to the memory 204 are optionally stored by the control unit 108, the computing device 110, and/or another device. In some embodiments, imaging device 216 includes memory that stores one or more parameters described with regard to the memory 204.

In some embodiments, the memory 204 stores a controlling system configuration that includes one or more system settings (e.g., as configured by a manufacturer, administrator, and/or user). For example, identifying information for the movable object 102 is stored as a system setting of the system configuration. In some embodiments, the controlling system configuration includes a configuration for the imaging device 216. The configuration for the imaging device 216 stores parameters such as position, zoom level and/or focus parameters (e.g., amount of focus, selecting autofocus or manual focus, and/or adjusting an autofocus target in an image). Imaging property parameters stored by the imaging device configuration include, e.g., image resolution, image size (e.g., image width and/or height), aspect ratio, pixel count, quality, focus distance, depth of field, exposure time, shutter speed, and/or white balance. In some embodiments, parameters stored by the imaging device configuration are updated in response to control instructions (e.g., generated by processor(s) 202 and/or received by the movable object 102 from control unit 108 and/or the computing device 110). In some embodiments, parameters stored by the imaging device configuration are updated in response to information received from the movable object sensing system 210 and/or the imaging device 216.

In some embodiments, a controlling system performs imaging device adjustment. The imaging device adjustment module stores, e.g., instructions for adjusting a distance between an image sensor and an optical device of an imaging device 216, e.g., instructions for controlling an imaging device actuator. In some embodiments, one or more instructions for performing imaging device adjustment are stored in the memory 204.

In some embodiments, the controlling system performs an autofocus operation. For example, the autofocus operation is performed, e.g., periodically, when a device determines from image analysis that a focus level has fallen below a focus level threshold, in response a determination that movable object 102 and/or an image subject (e.g., a target or a remote object) has moved by more than a threshold distance, and/or in response to user input. In some embodiments, user input (e.g., received at control unit 108 and/or computing device 110) initiates and/or adjusts an autofocus mode. In some embodiments, user input indicates one or more regions (e.g., in an image captured by imaging device 216, such as an image displayed by control unit 108 and/or computing device 110) to be used and/or prioritized for an autofocus operation. In some embodiments, the autofocus module generates control instructions for moving an optical device relative to an image sensor in accordance with an image distance value determined by an image distance determination module. In some embodiments, one or more instructions for performing an autofocus operation are stored in the memory 204.

In some embodiments, the controlling system performs image distance determination, e.g., to determine an object distance and/or an image distance in accordance with the operations described herein. For example, the image distance determination module uses sensor data from one or more depth sensors and one or more orientation sensors of a movable object to determine an image distance and generate a control instruction for moving an optical device relative to an image sensor in accordance with the determined image distance. In some embodiments, one or more instructions for performing image distance determination are stored in the memory 204.

The above identified controlling system, modules, and/or programs (e.g., sets of instructions) need not be implemented as separate software programs, procedures or modules, and thus various subsets of these modules may be combined or otherwise re-arranged in various embodiments, and stored in the memory 204. In some embodiments, the controlling system includes a subset of the modules and data structures identified above. Furthermore, the memory 204 may store additional modules and data structures not described above. In some embodiments, the programs, modules, and data structures stored in the memory 204, or a non-transitory computer readable storage medium of memory 204, provide instructions for implementing respective operations in the methods described below. In some embodiments, some or all of these modules may be implemented with specialized hardware circuits that subsume part or all of the module functionality. One or more of the above identified elements may be executed by one or more processors 202 of the movable object 102. In some embodiments, one or more of the above identified modules are stored on one or more storage devices of a device remote from the movable object (such as memory of the control unit 108, the computing device 110, and/or the imaging device 216) and/or executed by one or more processors of a device remote from the movable object 102 (such as processor(s) of the control unit 108, the computing device 110, and/or the imaging device 216).

The communication system 206 enables communication with the control unit 108 and/or the computing device 110, e.g., via wireless signals 112. The communication system 206 includes, e.g., transmitters, receivers, and/or transceivers for wireless communication. In some embodiments, the communication is one-way communication, such that data is only received by the movable object 102 from the control unit 108 and/or the computing device 110, or vice-versa. In some embodiments, communication is two-way communication, such that data is transmitted in both directions between the movable object 102 and the control unit 108 and/or the computing device 110. In some embodiments, the movable object 102, the control unit 108, and/or the computing device 110 are connected to the Internet 116 or other telecommunications network, e.g., such that data generated by the movable object 102, the control unit 108, and/or the computing device 110 is transmitted to a server for data storage and/or data retrieval (e.g., for display by a website).

In some embodiments, the sensing system 210 of the movable object 102 includes one or more sensors. In some embodiments, one or more sensors of the movable object sensing system 210 are mounted to the exterior, located within, or otherwise coupled to the movable object 102. In some embodiments, one or more sensors of the movable object sensing system 210 are components of and/or coupled to the carrier 104, the payload 106, and/or the imaging device 216. Where sensing operations are described herein as being performed by the movable object sensing system 210, it will be recognized that such operations are optionally performed by one or more sensors of the carrier 104, the payload 106, and/or the imaging device 216 in addition to and/or in lieu of one or more sensors of the movable object sensing system 210.

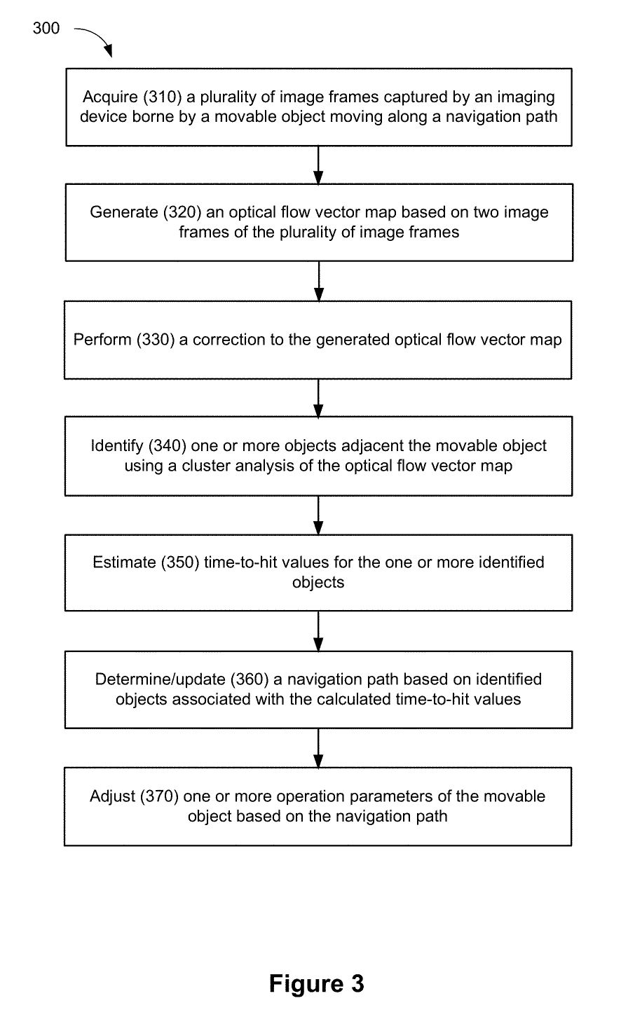

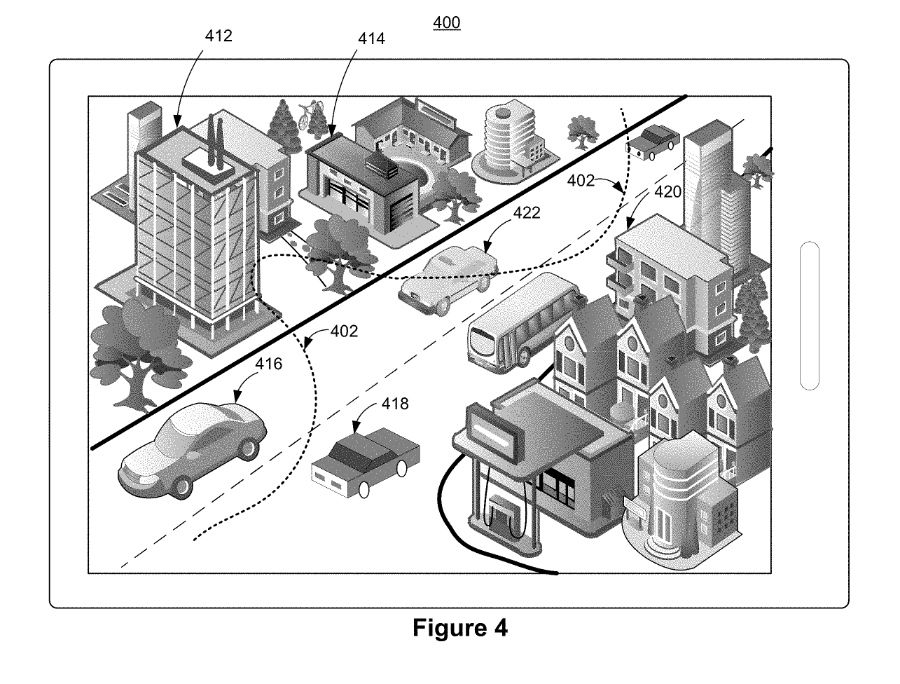

FIG. 3 is a diagram illustrating a method 300 of operating the movable object 102 to avoid obstacles, in accordance with some embodiments. In some embodiments, the method 300 is performed by an electronic device such as the computing device 110, the control unit 108, or the movable object 102 (FIG. 1). In some other embodiments, the method 300 is performed by other electronic device(s), such as a mobile device or a computing device paired with the control unit 108 for operating the movable object 102. Operations performed in FIG. 3 correspond to instructions stored in computer memories or other computer-readable storage mediums of the corresponding device(s). One or more steps of method 300 are further illustrated in FIGS. 4-9, which are discussed in combination with FIG. 3 in the present disclosure.

In some embodiments, the electronic device acquires (310) a plurality of image frames. The plurality of image frames are captured by the imaging device 216 borne by the movable object 102 when the movable object 102 moves along a navigation path, such as navigation path 402 shown in FIG. 4. In some embodiments, the plurality of image frames are a series of image frames of a video captured at a periodic rate within a predefined time window.

FIG. 4 illustrates an exemplary user interface 400 for operating the movable object 102 as the movable object 102 moves along the navigation path 402, in accordance with some embodiments. In FIG. 4, the user interface 400 displays an image frame of one or more image frames captured by the imaging device 216. Alternatively, the user interface 400 displays a map for navigating the movable object 102. In some embodiments, the user interface 400 is shown on the display 120 of the control unit 108. Alternatively, the user interface 400 is shown on a display of another electronic device, such as a display of the computing device 110 or an electronic device paired with the control unit 108 for the controlling the movable object 102. In some embodiments, the movable object 102 is manually controlled by the control unit 108, and the navigation path 402 is a path along which the movable object 102 moves in response to navigation control instructions received from the control unit 108. In some alternative embodiments, the movable object 102 is operated under an auto pilot mode and the navigation path 402 is a path predetermined based on one or more preset parameters, such as waypoints.

In some embodiments, an image frame displayed on the user interface 400 includes one or more objects, such as objects 412, 414, 416, 418, 420, and 422. One or more objects are located on the navigation path 402, such as objects 412 and 422. If the movable object 102 continues along the navigation path 402, the movable object 102 would collide with the objects 412 and 422. The objects located on the navigation path that would cause collisions with the movable object 102 are also referred to as obstacles (e.g., obstacles 412 and 422) in the present application.

In some embodiments, the one or more objects, including obstacles, are substantially static objects, such as a manmade and/or a natural structure, e.g., a traffic sign, a radio tower, a building (e.g., obstacle 412), a bridge, or a geological feature. In some embodiments, one or more objects, including obstacles, are dynamic objects, such as a vehicle (e.g., obstacle 422), a tree, a human, an animal, or another movable object (e.g., another UAV). In order to avoid a collision between the movable object 102 and an obstacle, it is important to detect one or more objects in the environment of the movable object 102 during the movement of the movable object 102, such that the navigation path can be timely adjusted to avoid collisions with one or more obstacles on the navigation path.

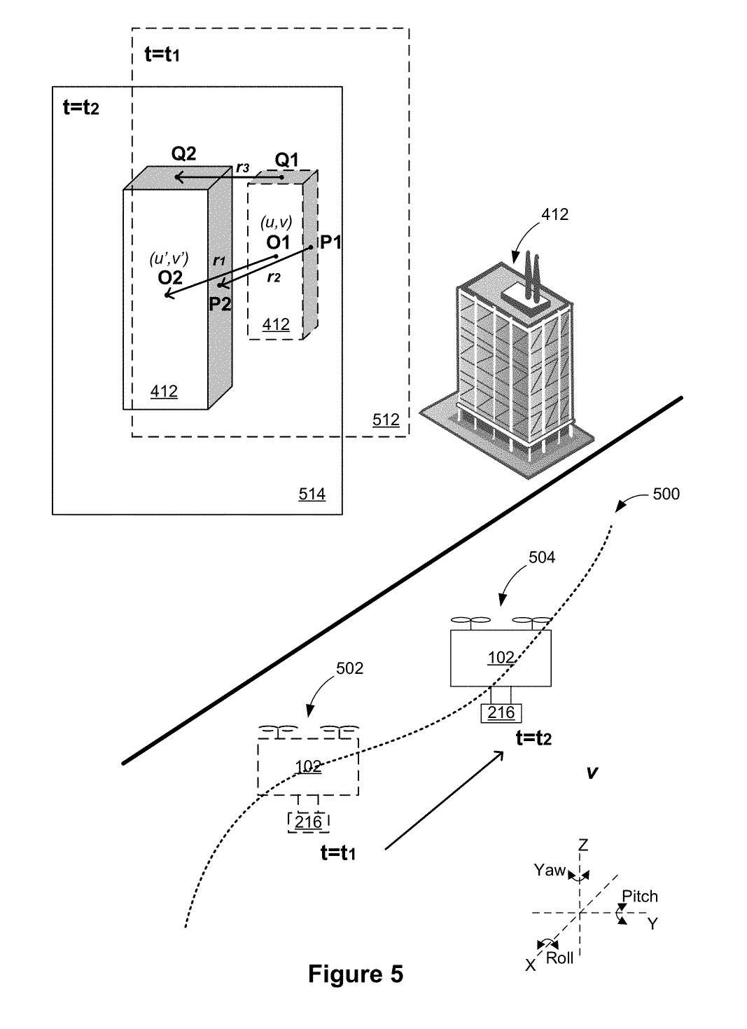

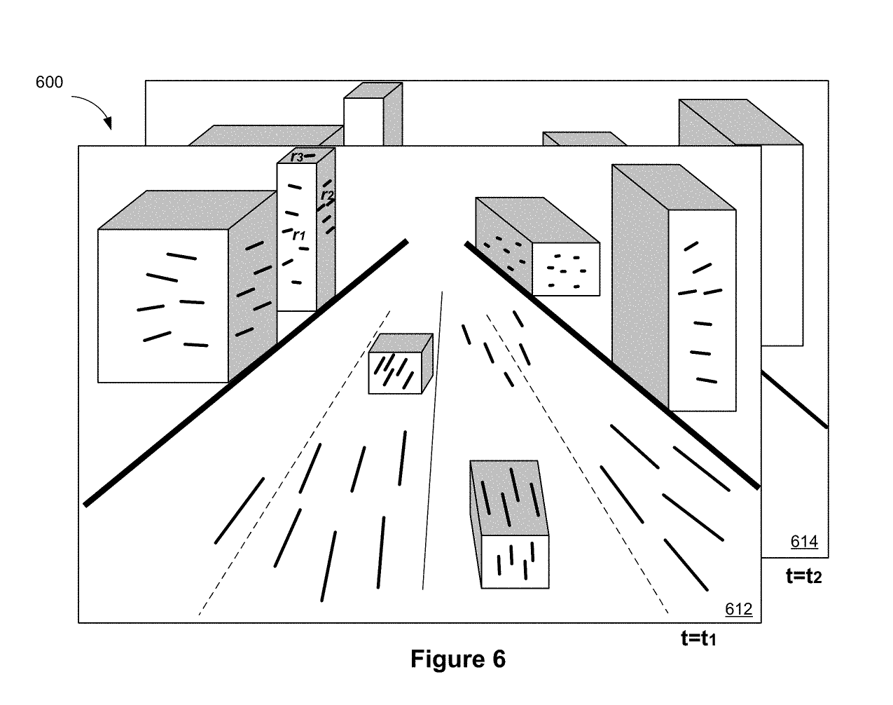

Referring back to FIG. 3, after acquiring the plurality of image frames, method 300 proceeds to generate (320) an optical flow vector map based on two image frames of the plurality of image frames. In some embodiments, generating the optical flow vector map at process step 320 includes identifying one or more optical flow vectors based on two image frames and forming the optical flow vector map including the one or more optical flow vectors. The two image frames may be two consecutive image frames of a video. More details about identifying optical flow vectors and forming the optical flow vector map are discussed with reference to FIGS. 5-6.

FIG. 5 is an exemplary diagram illustrating one or more optical flow vectors, such as optical flow vectors r=\vec{O₁O₂}, r₂=\vec{P₁P₂}, and r₃=\vec{Q₁Q₂}, formed based on two image frames, e.g., image frame 512 captured at t₁ and image frame 514 captured at t₂, in accordance with some embodiments. In some embodiments, an optical flow vector is a vector indicating the movement of a same point from a first image frame to a second image frame captured subsequent to the first image frame. In some embodiments, the point is a pixel or includes a group of pixels or a cluster of pixels indicating the same region in the first and the second image frames. In some embodiments, the second image frame is immediately subsequent to or at a certain number of frames subsequent to the first image frame. In some embodiments, an optical flow vector is an optical flow indicating the 2-dimensional (2D) projection of the physical movement (e.g., 3-D movement) of a point (e.g., point O, P, or Q) relative to the imaging device 216. The optical flow indicates the 2D displacement of the point on the image plane of the imaging device 216.

In some embodiments, the movable object 102 moves along the navigation path 500, passing a first location 502 at a first time t₁, and a second location 504 at a second time t₂ later than the first time t₁. The movable object 102 is depicted with dashed lines at time t₁ to indicate a prior location, i.e., location 502, of the movable object 102 at a time prior to a current time, e.g., at time t₂ at which the movable object 102 is shown with solid lines. The imaging device 216 of the movable object 102 captures a first image frame 512 (shown in dashed lines) when the movable object 102 is at the first position 502 at time t₁. The imaging device 216 captures a second image frame 514 (shown in solid lines) when the movable object 102 is at the second position 504 at time t₂.

As discussed with reference to FIG. 2, in some embodiments, the carrier 104 includes one or more mechanisms, such as one or more actuators 212, to cause movement of carrier 104 and/or payload 106. In some embodiments, actuator 212 causes movement of frame member 202. In some embodiments, actuator 212 rotates payload 106 (carrying the imaging device 216) about one or more axes, such as three axes: Y axis (“pitch axis”), X axis (“roll axis”), and Z axis (“yaw axis”), relative to movable object 102. In some embodiments, actuator 212 translates payload 106 along one or more axes relative to movable object 102.

In some embodiments, the carrier 104, such as a gimbal and/or a damping element, is used to isolate the payload 106 including the imaging device 216 from movement of the movable object 102. Thus a position change (x) of the imaging device 216 from time t₁ to time t₂ can be small. A small angle approximation is used in the following calculations, where cos x≈1, sin x≈x. In some embodiments, a rotation matrix can be simplified using the small angle approximation as shown in equation (1):

$$R \approx [ \begin{matrix}1 & - ψ & θ \\ ψ & 1 & φ \\ - θ & φ & 1\end{matrix} ] = [ \begin{matrix}1 & 0 & 0 \\ 0 & 1 & 0 \\ 0 & 0 & 1\end{matrix} ] + [ \begin{matrix}0 & - ψ & θ \\ ψ & 0 & θ \\ - θ & φ & 0\end{matrix} ] = I + S , \qquad ( 1 )$$

where ϕ indicates a rotation of the imaging device 216 around roll (X) axis, θ indicates a rotation of the imaging device 216 around pitch (Y) axis, and ψ indicates a rotation of the imaging device 216 around yaw (Z) axis.

In some embodiments, an optical flow vector is an optical flow indicating the 2-dimensional (2D) projection of the physical movement of a point (e.g., point O, P, or Q) relative to the imaging device 216. The optical flow indicates the 2D displacement of the point on the image plane of the imaging device 216. As shown in FIG. 5, both image frames 512 and 514 include the image of the object 412. Because of the location and/or position variations of the imaging device 216, the size and/or the location of the object 412 in image frames 512 and 514 also change. The vector r₁ is an optical flow vector connecting the same point, such as O1 (u,v) and O2 (u′,v′), from image frame 512 to image frame 514. The changes from O1 to O2 can be shown in equations (2) and (3):

$$\begin{matrix}{u}^{′} - u = f {ω}_{Y} - v {ω}_{Z} + \frac{{u}^{2}}{f} {ω}_{Y} - \frac{uv}{f} {ω}_{X} + f \frac{{T}_{X}}{Z} - u \frac{{T}_{Z}}{Z} , & ( 2 ) \\ {v}^{′} - v = - f {ω}_{X} + v {ω}_{Z} - \frac{{u}^{2}}{f} {ω}_{X} + \frac{uv}{f} {ω}_{Y} + f \frac{{T}_{Y}}{Z} - v \frac{{T}_{Z}}{Z} . & ( 3 )\end{matrix}$$

Equations (2) and (3) can be further represented in equations (4) and (5):

$$\begin{matrix}{u}^{′} - u = - \frac{uv}{f} {ω}_{X} + ( f + \frac{{u}^{2}}{f} ) {ω}_{Y} - v {ω}_{Z} + \frac{f}{z} {T}_{X} - \frac{u}{z} {T}_{Z} , & ( 4 ) \\ {v}^{′} - v = - ( f + \frac{{u}^{2}}{f} ) {ω}_{X} + \frac{uv}{f} {ω}_{Y} + v {ω}_{Z} + f \frac{{T}_{Y}}{z} - \frac{v}{z} {T}_{Z} , & ( 5 )\end{matrix}$$

which can be further represented in matrix (6) as below:

$$[ \begin{matrix}\vec{u} \\ \vec{v}\end{matrix} ] = A ω + BT , \qquad ( 6 )$$

where A and B can be represented in matrix (7) and matrix (8) as below:

$$\begin{matrix}A = [ \begin{matrix}- \frac{uv}{f} & f + \frac{{u}^{2}}{f} & - v \\ - ( f + \frac{{u}^{2}}{f} ) & \frac{uv}{f} & v\end{matrix} ] , & ( 7 ) \\ B = [ \begin{matrix}\frac{f}{z} & 0 & - \frac{u}{z} \\ 0 & \frac{f}{z} & - \frac{v}{z}\end{matrix} ] , & ( 8 )\end{matrix}$$

where ω is an angular velocity of the imaging device 216 moving from t₁ to t₂. ω can be indicated by matrix (9) as below:

ω=[ω_{X}ω_{Y}ω_{Z}]^{T} (9),

where ω_{X}, ω_{Y}, and ω_{Z} are angular velocities along X, Y, and Z directions respectively. T is a linear velocity of the imaging device 216 moving from t₁ to t₂, and T can be indicated by matrix (10) as below:

T=[T_{X}T_{Y}T_{Z}]^{T} (10),

and f is the focal length of the imaging device 216. Similarly, optical flow vectors r₂ and r₃ can be illustrated using similar form as discussed above.

FIG. 6 illustrates an exemplary user interface of an optical flow vector map 600 including a plurality of vectors (e.g., including vectors r₁, r₂ and r₃) formed based on image frame 612 captured at t₁ and image frame 614 captured at t₂, in accordance with some embodiments. In some embodiments, referring back to FIG. 3, the electronic device performs (330) a correction to the optical flow vector map 600 generated at process step 320. For example, the electronic device uses a Random Sample Consensus (RANSAC) procedure to detect and remove one or more outliers in the optical flow vector map 600. In some embodiments, an upper limit number (k) of samples are selected to guarantee a correct solution using RANSAC procedure without replacement, where k is indicated by equation (11) as below:

$$k = \frac{log ( 1 - p )}{log ( 1 - {w}^{n} )} . \qquad ( 11 )$$

In equation (11), p is a probability that the algorithm in some iteration selects only inliers from the input data set when it chooses the n points from which the model parameters are estimated. Thus p is the probability that the algorithm produces a useful result. Furthermore, w is the probability of choosing an inlier each time a single point is selected, that is w=(number of inliers in data)/(number of points in data). Assuming that the n points needed for estimating a model are selected independently, wⁿ is the probability that all n points are inliers and 1−wⁿ is the probability that at least one of the n points is an outlier. In some embodiments, k is multiplied by a factor of ten. In some embodiments, RANSAC procedures are performed adaptively, e.g., iteration after iteration.

Method 300 proceeds to identify (340) one or more objects adjacent the movable object 102 using a cluster analysis of the generated optical flow vector map. For example, the plurality of optical flow vectors are grouped by lengths and directions of respective optical flow vectors. In some embodiments, one or more optical flow vectors in a same group have similar lengths and directions. For example, the length variation and/or the size variation between any two optical flow vectors within a group is within a predetermined range. Similar optical flow vectors within a group may have similar depth of field (DOF). For example, one or more optical flow vectors within a group are on the same collision plane and have the same collision distance from the movable object 102. In some embodiments, one or more optical flow vectors within a same group are categorized to be related to a same object adjacent the movable object 102. In some embodiments, an object including a group of optical flow vectors correspond to a collision plane that collides with the movable object 102 at the same time-to-hit value.

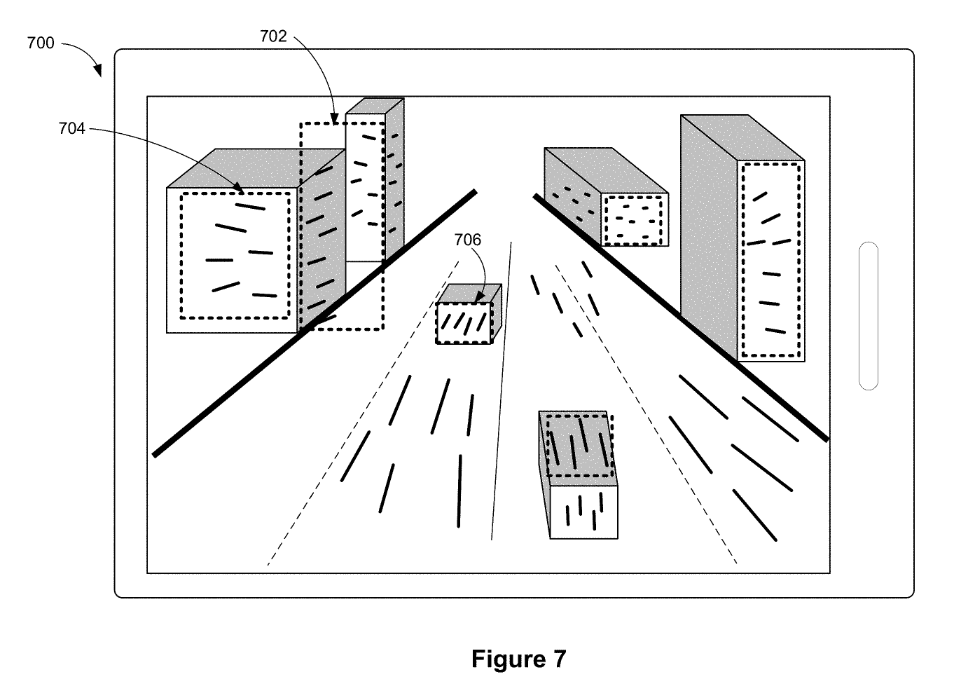

FIG. 7 illustrates an exemplary user interface 700 of identifying one or more objects based on the optical flow vector map, in accordance with some embodiments. In some embodiments, graphical tracking indicators 702, 704, and 706, are displayed on user interface 700 to indicate one or more identified objects at step 340 of the method 300. In some embodiments, the graphical object identification indicators are automatically generated, displayed, and updated as the movable object moves along the path. For example, a graphical tracking indicator indicating an identified object includes dashed lines in rectangular, square, circle, and/or other polygonal shape that enclose one or more optical flow vectors from the same group.

The electronic device tracks the identified one or more objects to obtain frame-to-frame variations of each object. For example, the electronic device tracks the one or more objects as the movable object 102 moves and obtains size variations of each object from one image frame to another image frame, e.g., a subsequent image frame. In some embodiments, the object identification process is performed in real time as the movable object 102 moves. Each optical flow vector in the optical flow vector map gets updated as the movable object 102 moves. As a result, the shape, size, and/or location of each graphical tracking indicator may change. In some embodiments, when length variations or direction variations of one or more optical flow vectors from the first moment to the second moment are above predetermined threshold, the optical flow vectors in the optical flow vector map may be regrouped. As such, the identified objects may be different from the first moment to the second moment.

Referring back to FIG. 3, method 300 proceeds to estimate (350) time-to-hit values for the one or more identified objects. In some embodiments, the electronic device estimates movements of the one or more identified objects relative to the movable object 102. For example, the electronic device estimates a time-to-hit value for each identified object to collide with the movable object 102 as the movable object 102 moves along the path.

In some embodiments, the electronic device identifies an object that has a distance X(t) from the movable object 102 at a time point t. If an initial distance between the object and the movable object 102 is d, and the velocity of the movable object 102 is v at the time point t, then the distance X(t) at the time point t can be determined by equation (12) as below:

X(t)=d−vt (12).

If the real dimension of the object is M*N, and the dimension of the object projected on the image plane of is m*n, the dimension of the object projected on the image plane can be determined based on equations (13) and (14):

$$\begin{matrix}m = f \frac{M}{X ( t )} , & ( 13 ) \\ n = f \frac{N}{X ( t )} , & ( 14 )\end{matrix}$$

where f is the focal length of the imaging sensor 216 borne by the movable object 102. A dimension variation can be expressed in equation (15) as below,

$${m}^{′} = \frac{dm}{dt} = - f \frac{M}{{X ( t )}^{2}} \frac{dX ( t )}{dt} . \qquad ( 15 )$$

### Because

$$\frac{dX ( t )}{dt} = - v , \qquad ( 16 )$$

equation (15) can be further expressed as:

$${m}^{′} = f \frac{Mv}{{X ( t )}^{2}} . \qquad ( 17 )$$

### Thus

$$\frac{m}{{m}^{′}} = \frac{f \frac{M}{X ( t )}}{f \frac{Mv}{{X ( t )}^{2}}} = \frac{X ( t )}{v} = {Δ t}_{1} , \qquad ( 18 )$$

where Δt₁ is a first time-to-hit value for the movable object 102 to collide with the object estimated using dimension m. A second time-to-hit value Δt₂ associated with the same object can be determined using the dimension variation

$$\frac{n}{{n}^{′}} .$$

A time-to-hit value Δt associated with the object can be determined by Δt₁ and Δt₂. For example, Δt may be an average of Δt₁ and Δt₂. In another example, Δt₁ and Δt₂ can be assigned with respective weights w₁ and w₂ respectively based on the confidence level estimated by the imaging system, where w₁+w₂=1. In some embodiments, the dimension of the object projected on the image plane and the dimension variation between the acquired image frames can be determined by measuring the number of pixels the object occupies in the acquired image. For example, it is not difficult to identify an object of known dimension (e.g., a car or a human being) in the image. Based on the number of pixels occupied by the known object and its physical dimension, the dimension of the object projected on the image plane can be estimated from the number of pixels occupied by the object in the same image.

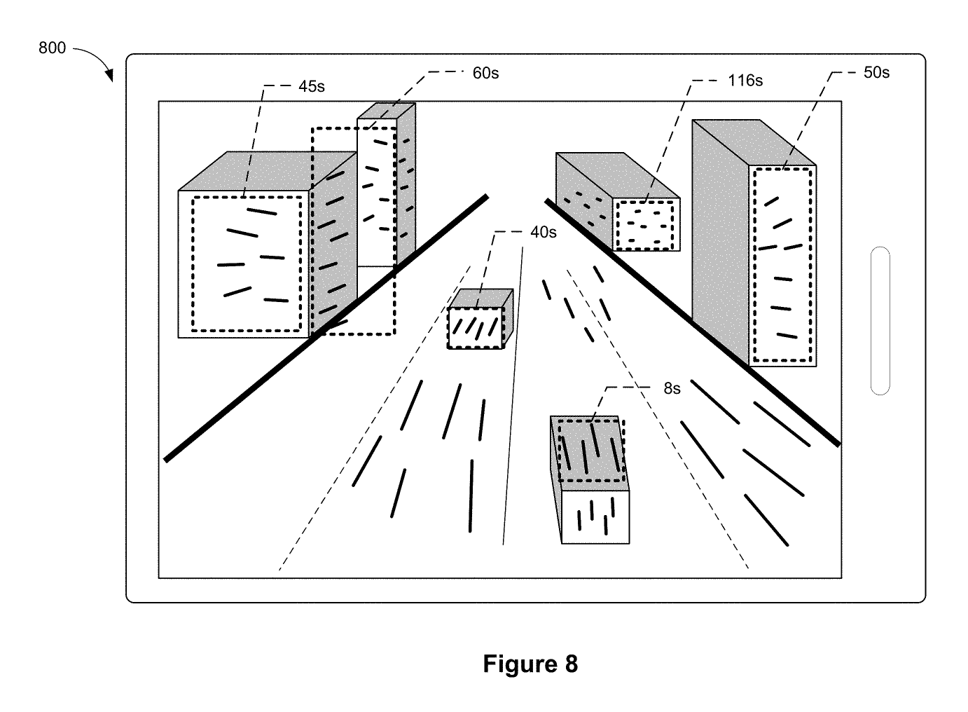

FIG. 8 illustrates an exemplary user interface 800 for displaying time-to-hit values associated with one or more objects. In some embodiments, the time-to-hit values can be determined based on the dimension of the object projected on the image plane and the dimension variation between the acquired image frames as discussed above. Each graphical tracking indicator is associated with a time-to-hit value that is displayed on the user interface 800, such as 45 s, 60 s, 116 s, 50 s, 40 s, and 8 s. As the movable object 102 moves along a path, the time-to-hit value associated with each object is estimated and updated on the user interface 800 in real time. In some embodiments, when the time-to-hit value associated with an object is less than a predetermined threshold value (e.g., 5 s), a warning or an alert (e.g., a visual or an audio indicator) associated with the object is provided to the user. In some embodiments, the object with a time-to-hit value that is below the predetermined threshold value is highlighted on the display to warn the user of the danger of collision. In some embodiments, a region including one or more object that are too close to the movable object (e.g., with time-to-hit values below the predetermined threshold value) is highlighted on the display to warn the user. The time-to-hit values for the one or more objects on the display are calculated and updated in real time, and warnings, alerts, and/or highlights are also provided to the user in real time as the movable object moves along the path.

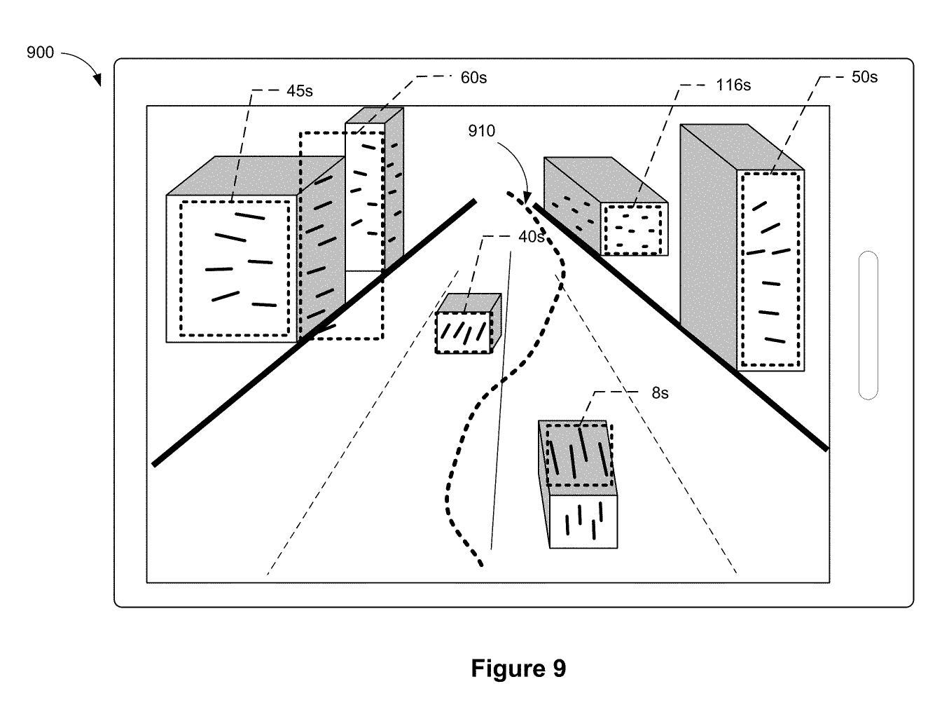

After calculating the time-to-hit values of the one or more objects on the path, the electronic device determines or updates (360) a navigation path to avoid collisions between the movable object 102 and the one or more objects on the path. The electronic device then adjusts (370) one or more operation parameters of the movable object 102 based on the updated navigation path. FIG. 9 illustrates an exemplary user interface 900 of displaying a navigation path 910 for operating a movable object 102 to avoid obstacles, in accordance with some embodiments. After calculating the time-to-hit values for the one or more objects, the navigation path 910 is updated such that the movable object 102 moves towards an object that has the longest time-to-hit value (e.g., 116 seconds). The operation parameters of the movable object 102 are adjusted such that the movable object 102 moves along the updated navigation path to avoid collisions with obstacles. In some embodiments, as the movable object 102 moves, the one or more objects are identified in real time as shown in FIG. 7, the time-to-hit values associated with the one or more objects are estimated and updated on the user interface in real time as shown in FIG. 8, and the navigation path is constantly updated to avoid collisions with obstacles in real time as shown in FIG. 9.

In some embodiments, when the time-to-hit values for all the objects are less than a predetermined threshold time value, it is determined that all the objects are too close to the movable object 102. It is highly likely that the movable object 102 will hit an object sooner than the navigation path can be timely adjusted to avoid the collision. The one or more operation parameters of the movable object 102 may be adjusted to allow the movable object 102 to hover statically at a current position. A notification may be further displayed on the user interface to notify the user.

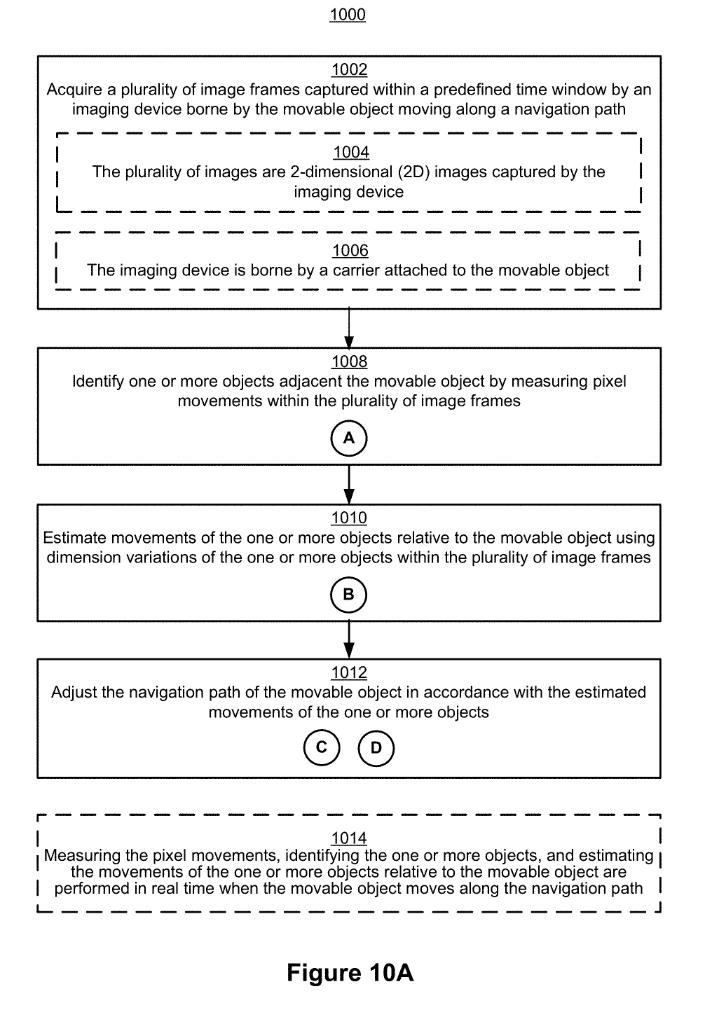

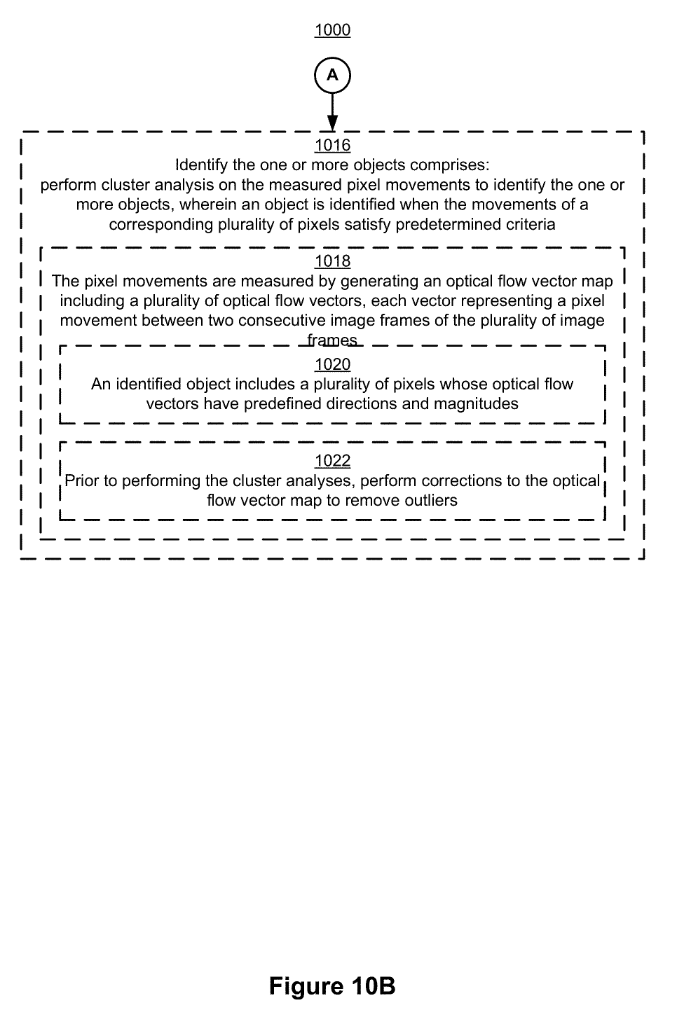

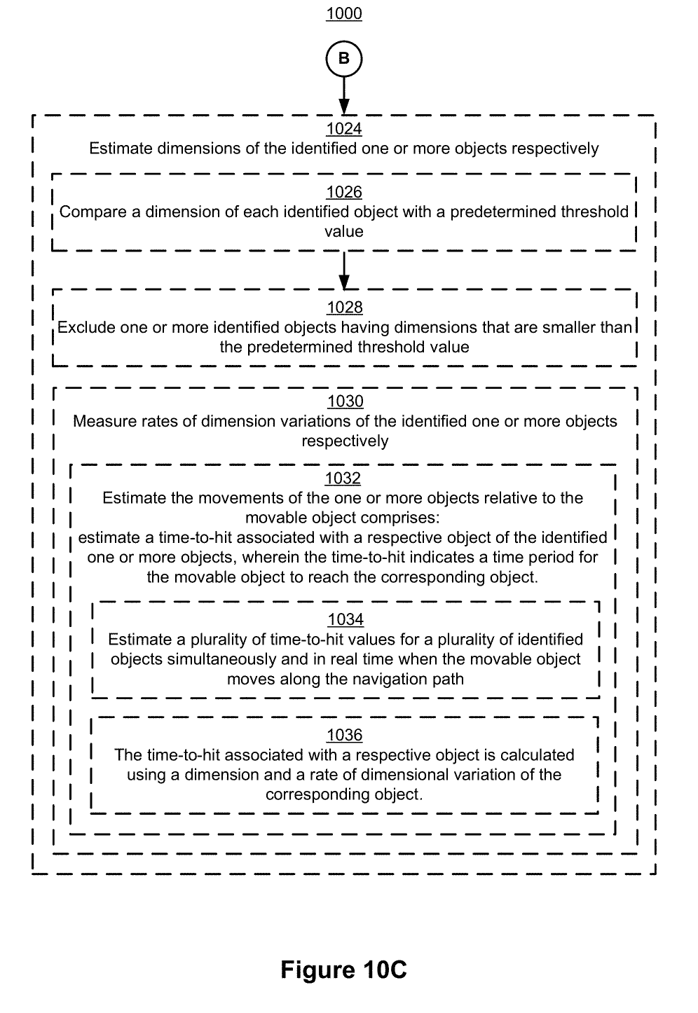

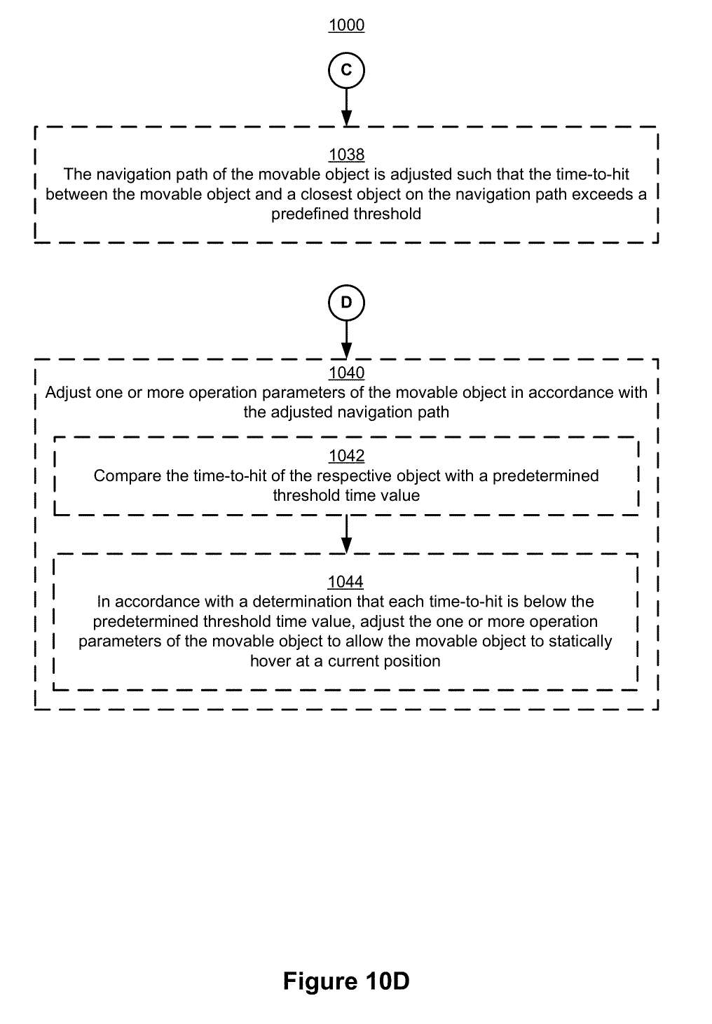

FIGS. 10A-10D are a flow diagram illustrating a method 1000 for operating a movable object 102, in accordance with some embodiments. The method 1000 is performed at an electronic device, such as the movable object 102, the imaging device 216, the control unit 108, and/or the computing device 110. In some other embodiments, the method 1000 is performed by other electronic device(s), such as a mobile device or a computing device paired with the control unit 108 for operating the movable object 102. Operations performed in FIG. 10 correspond to instructions stored in computer memories or other computer-readable storage mediums of the corresponding device(s).

The electronic device acquires (1002) a plurality of image frames. The plurality of image frames are captured within a predefined time window by the imaging device 216 borne by the movable object 102 moving along a navigation path. In some embodiments, the plurality of image frames are (1004) two-dimensional (2-D) images captured by the imaging device 216. In some other embodiments, the plurality of image frames are three-dimensional (3-D) images captured by an stereoscopic imaging system borne by the movable object 102. When the plurality of image frames are 3-D images, the method 1000 may not need to use the disparity information from the 3-D images to determine the distance between an obstacle and the movable object 102. In some embodiments, the imaging device 216 is (1006) borne by the carrier 104 that is attached to the movable object 102, such that position changes of the imaging device 216 between adjacent two or more image frames are relatively small. Thus sooth images capturing can be provided and a small-angle approximation can be applied to the above calculations of the optical flow vectors.

The electronic device identifies (1008) one or more objects adjacent the movable object 102 by measuring pixel movements within the plurality of image frames. For example as shown in FIG. 5, the electronic device measures movements of the pixels corresponding to the same point from a first image frame (e.g., image frame 512) to a second image frame (e.g., image frame 514). In some embodiments, the electronic device performs (1016) cluster analysis on the measured pixel movements to identify the one or more objects. An object is identified when the movements of a corresponding plurality of pixels satisfy predetermined criteria. For example, the movements of the corresponding plurality of pixels share similar directions and magnitudes. In other words, the direction change and magnitude change of a plurality of pixels corresponding to an identified object are below predetermined change thresholds respectively.

In some embodiments as discussed with reference to FIGS. 6 and 7, the pixels movements are measured by generating (1018) an optical flow vector map including a plurality of optical flow vectors. Each optical flow vector is a 2-D optical flow representing a 3-D motion change. In some embodiments, each optical flow vector represents a pixel movement between two consecutive image frames of the plurality of image frames. In some other embodiments, each optical flow vector represents a movement of a plurality of pixels between two consecutive image frames of the plurality of image frames. In some embodiments, an identified object includes portions from more than one obstacle included in the image frames. For example as shown in FIG. 7, an identified object 702 includes two sides from two different buildings. These two sides of the two different buildings may appear to be located on the same collision plane, which may collide with the movable object 102 at the same time. As shown in FIG. 7, each identified object is associated with a graphical tracking indicator, such as a 2-D dashed box. The graphical tracking indicator changes dynamically as the movable object 102 moves along the navigation path. In some embodiments, an identified object includes (1020) a plurality of pixels whose optical flow vectors have predefined direction and magnitudes. For example, the direction variance and magnitude variance of the optical flow vectors that belong to the same identified object are within predetermined thresholds. In some embodiments, prior to performing the cluster analyses, the electronic device performs (1022) corrections to the optical flow vector map to remove outliers. For example, the electronic device uses RANSAC procedure to detect and remove one or more outliers in the optical flow vector map.

After identifying the one or more objects, the electronic device estimates (1010) movements of the one or more objects relative to the movable object 102 using dimension variations of the one or more objects within the plurality of image frames. In some embodiments, the electronic device estimates (1024) dimensions of the identified one or more objects respectively. In some embodiments, the electronic device compares (1026) the dimension of each identified object with a predetermined threshold value. The electronic device excludes (1028) one or more identified objects having dimensions that are smaller than the predetermined threshold value.

In some embodiments, the electronic device measures (1030) rates of dimension variations of the identified one or more objects respectively. The electronic device estimates (1032) a time-to-hit value (e.g., Δt as discussed with reference to the process step 350 of method 300, FIG. 3) associated with a respective object of the identified one or more objects. The time-to-hit value indicates a time period for the movable object to reach the corresponding object. In some embodiments, the electronic device estimates (1034) a plurality of time-to-hit values for a plurality of identified objects simultaneously and in real time when the movable object 102 moves along the navigation path. For example as shown in FIG. 8, the plurality of time-to-hit values are displayed on the user interface and are updated in real time as the movable object 102 moves along the navigation path. In some embodiments, the time-to-hit value associated with a respective object is (1036) estimated using a dimension and a rate of dimensional variation of the corresponding object. For example, the time-to-hit value is a ratio of a dimension of the object divided by a rate of dimensional variation between two image frames as illustrated in equation 18.

The electronic device adjusts (1012) the navigation path of the movable object 102 in accordance with the estimated movements of the one or more objects. In some embodiments, the navigation path of the movable object 102 is adjusted (1038) such that the time-to-hit value between the movable object 102 and a closest object on the navigation path exceeds a predefined threshold. For example, when a predefined threshold is 2 seconds, the navigation path is adjusted such that that the time period for the movable object 102 to hit the closest object on the adjusted navigation path is more than 2 seconds.

In some embodiments, the electronic device adjusts (1040) one or more operation parameters of the movable object 102 in accordance with the adjusted navigation path. The electronic device compares (1042) the time-to-hit value of the respective object with a predetermined threshold time value (e.g., 2 seconds). In accordance with a determination that each time-to-hit value is below the predetermined threshold time value, the electronic device adjusts (1044) the one or more operation parameters of the movable object 102 to allow the movable object 102 to statically hover at a current position. The electronic device may further send a notification for display on the user interface to notify the user.

In some embodiments, the above described (1) measuring the pixel movements, (2) identifying the one or more objects, and (3) estimating the movements of the one or more objects relative to the movable object 102 are performed (1014) in real time when the movable object 102 moves along the navigation path.

Many features of the present disclosure can be performed in, using, or with the assistance of hardware, software, firmware, or combinations thereof. Consequently, features of the present disclosure may be implemented using a processing system. Exemplary processing systems (e.g., processor(s) 202) include, without limitation, one or more general purpose microprocessors (for example, single or multi-core processors), application-specific integrated circuits, application-specific instruction-set processors, field-programmable gate arrays, graphics processors, physics processors, digital signal processors, coprocessors, network processors, audio processors, encryption processors, and the like.

Features of the present disclosure can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 204) can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems, and execution environments/containers.

Communication systems as referred to herein (e.g., the communication system 206) optionally communicate via wired and/or wireless communication connections. For example, communication systems optionally receive and send RF signals, also called electromagnetic signals. RF circuitry of the communication systems convert electrical signals to/from electromagnetic signals and communicate with communications networks and other communications devices via the electromagnetic signals. RF circuitry optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Communication systems optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), spread spectrum technology such as FASST or DESST, or any other suitable communication protocol, including communication protocols not yet developed as of the filing date of this document.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method for operating a movable object, comprising:
acquiring a plurality of image frames captured within a predefined time window by an imaging device borne by the movable object moving along a navigation path;
identifying one or more objects adjacent the movable object by measuring pixel movements within the plurality of image frames;
estimating movements of the one or more objects relative to the movable object using dimensional variations of the one or more objects within the plurality of image frames; and
adjusting the navigation path of the movable object in accordance with the estimated movements of the one or more objects.

2. The method of claim 1, wherein identifying the one or more objects comprises:
performing cluster analysis on the measured pixel movements to identify the one or more objects, wherein an object is identified when the movements of a plurality of pixels corresponding to the object satisfy predetermined criteria.

3. The method of claim 2, wherein the pixel movements are measured by generating an optical flow vector map including a plurality of optical flow vectors, each vector representing a pixel movement between two consecutive image frames of the plurality of image frames.

4. The method of claim 1, further comprising:
estimating dimensions of the identified one or more objects respectively.

5. The method of claim 4, further comprising:
comparing a dimension of each identified object with a predetermined threshold value; and
excluding at least one of the identified one or more objects having dimensions that are smaller than the predetermined threshold value.

6. The method of claim 4, further comprising:
measuring rates of dimensional variations of the identified one or more objects respectively.

7. The method of claim 1, wherein estimating the movements of the one or more objects relative to the movable object comprises:
estimating a time-to-hit associated with a respective object of the identified one or more objects, wherein the time-to-hit associated with a corresponding object indicates a time period for the movable object to reach the corresponding object.

8. The method of claim 7, further comprising:
estimating a plurality of time-to-hit values for a plurality of identified objects simultaneously and in real time when the movable object moves along the navigation path.

9. The method of claim 7, wherein the time-to-hit associated with the corresponding object is estimated using a dimension and a rate of dimensional variation of the corresponding object.

10. The method of claim 7, wherein the navigation path of the movable object is adjusted such that the time-to-hit between the movable object and a closest object among the identified one or more objects on the navigation path exceeds a predefined threshold.

11. The method of claim 7, further comprising:
adjusting one or more operation parameters of the movable object in accordance with the adjusted navigation path.

12. The method of claim 11, further comprising:
comparing the time-to-hit of the respective object with a predetermined threshold time value; and
in accordance with a determination that the time-to-hit of each of the identified one or more objects is below the predetermined threshold time value, adjusting the one or more operation parameters of the movable object to allow the movable object to statically hover at a current position.

13. A system for operating a movable object, the system comprising:
an imaging device comprising an image sensor and an optical device;
one or more processors coupled to the imaging device; and
a memory storing one or more programs that, when executed by the one or more processors, cause the one or more processors to:
acquire a plurality of image frames captured within a predefined time window by the imaging device borne by a movable object moving along a navigation path;
identify one or more objects adjacent the movable object by measuring pixel movements within the plurality of image frames;
estimate movements of the one or more objects relative to the movable object using dimensional variations of the one or more objects within the plurality of image frames; and
adjust the navigation path of the movable object in accordance with the estimated movements of the one or more objects.

14. An unmanned aerial vehicle (UAV), comprising:
a propulsion system;
one or more sensors;
an imaging device comprising an image sensor and an optical device; and
one or more processors coupled to the propulsion system, the one or more sensors, and the imaging device, the one or more processors being configured to:
acquire a plurality of image frames captured within a predefined time window by the imaging device borne by the UAV moving along a navigation path;
identify one or more objects adjacent the UAV by measuring pixel movements within the plurality of image frames;
estimate movements of the one or more objects relative to the UAV using dimensional variations of the one or more objects within the plurality of image frames; and
adjust the navigation path of the UAV in accordance with the estimated movements of the one or more objects.

15. The UAV of claim 14, wherein the one or more processors are further configured to:
estimate dimensions of the identified one or more objects respectively.

16. The UAV of claim 15, wherein the one or more processors are further configured to:
measure rates of dimensional variations of the identified one or more objects respectively.

17. The UAV of claim 14, wherein estimating the movements of the one or more objects relative to the UAV comprises:
estimating a time-to-hit associated with a respective object of the identified one or more objects, wherein the time-to-hit associated with a corresponding object indicates a time period for the UAV to reach the corresponding object.

18. The UAV of claim 17, wherein the one or more processors are further configured to:
estimate a plurality of time-to-hit values for a plurality of identified objects simultaneously and in real time when the UAV moves along the navigation path.

19. The UAV of claim 17, wherein the one or more processors are further configured to:
adjust one or more operation parameters of the UAV in accordance with the adjusted navigation path.

20. The UAV of claim 19, wherein the one or more processors are further configured to:
compare the time-to-hit of the respective object with a predetermined threshold time value; and
in accordance with a determination that the time-to-hit of each of the identified one or more objects is below the predetermined threshold time value, adjust the one or more operation parameters of the UAV to allow the UAV to statically hover at a current position.
